(19) United States
(12) Patent Application Publication
(10) Pub. No.: US 2007/0250228 A1
(43) Pub. Date: Oct. 25, 2007

(54) Configurable method and system for vehicle fault alert

(75) Inventors: Sunil Reddy, Corpus Christi, TX (US); Dale Trsar, Mount Prospect, IL (US); Robert J. Hoevenaar, Amsterdam (NL)

Correspondence Address: MCDERMOTT WILL & EMERY LLP, 600 13TH STREET, N.W., WASHINGTON, DC, 20005-3096, US

(73) Assignee: SNAP-ON INCORPORATED

(21) Appl. No.: 11/406,895

(22) Filed: Apr. 19, 2006

(51) Int. Cl. G01M 17/00; G06F 19/00

(52) U.S. Cl. 701/29; 701/33; 701/2

(57) ABSTRACT

Configurable methods and systems allowing a user remote to a vehicle to designate the types of faults or information that an on-board diagnostic system of the vehicle should monitor and report.

### FIELD OF DISCLOSURE

The present disclosure relates to configurable methods and systems for obtaining vehicle fault alert, and more specifically, to a data processing system external to a vehicle that allows a user to designate the type of faults or information that an on-board diagnostic system of the vehicle should monitor and report.

### BACKGROUND OF THE DISCLOSURE

The automotive diagnostic industry has been collecting data related to faults occurring on vehicles for identifying trends of faults or possible design defects. Traditionally, the data collection process is performed by garages or service centers when vehicles are brought in for service or maintenance. Technicians are asked to perform diagnostic processes on the vehicles and enter their observations into a computer. The entered data is later sent to a central data depository for further processing. However, this data collection process is often tedious and requires a lot of human work and intervention.

Furthermore, a lot of faults occurring on vehicles do not have any manifested symptoms or do not need immediate services. As a result, drivers often are unaware of, or do not care, the existence of the faults and will not bring the vehicles to service centers for service right away. Accordingly, the fault data is unavailable for collection when they occur.

Therefore, there is a need to provide a seamless process of collecting fault data. There is another need to obtain vehicle fault data as soon as the faults occur. There is also a need for a flexible data collection process that allows a user to designate the type of faults that an on-board diagnostic system of a vehicle should monitor and report.

### SUMMARY OF THE DISCLOSURE

This disclosure describes configurable methods and systems allowing a user remote to a vehicle to designate the types of faults or information that an on-board diagnostic system of the vehicle should monitor and report. The vehicle can be any types of transportation means, such as automobiles, vessels, airplanes, ships, boats, etc.

An exemplary method of this disclosure receives a configurable command from the external of the vehicle. The command specifies a specific fault event associated with the vehicle. The operation of the vehicle is monitored. Responsive to an occurrence of the specified fault event, information related to the fault event is prepared and provided to a data processing system external to the vehicle. In one aspect, the information is transmitted to the data processing system in a wireless manner. In another aspect, the command is received from the data processing system in a wireless manner, such as a wireless telephone network, or from a device connected to a data port of the vehicle. The command may specify at least one of identification of the vehicle, a controller of the vehicle, a subsystem of the vehicle, and a type of fault to be monitored.

According to another embodiment, fault alerts related to a vehicle are obtained by generating a command specifying a fault event associated with the vehicle and transmitting the command from the external of the vehicle to an on-board diagnostic system of the vehicle. The command specifies at least one of identification of the vehicle, at least one controller of the vehicle, at least one subsystem of the vehicle, and at least one type of fault or information to be monitored.

The command may include information for establishing communications with a designated data processing system external to the vehicle. According to one embodiment, an additional step is performed to receive information related to an occurrence of the specified fault event from the on-board diagnostic system of the vehicle. The information related to the occurrence of the specified fault event is generated by the on-board diagnostic system by monitoring the operation of the vehicle, and responsive to the occurrence of the specified fault event, preparing the information related to the specified fault event. Based on the received command, the on-board vehicle diagnostic system establishes communications with the designated data processing system to convey the prepared information. The designated system may be the same system that generates the command, or may be different from a system that generates the command. In one aspect, the communications with the designated data processing system is established in a wireless manner. In another aspect, the command is generated based on an input from a user.

An exemplary data processing system for obtaining fault alerts associated with a vehicle includes a data processor configured to process data, and a data storage system storing instructions which, upon execution by the data processor, control the data processor to perform the steps of generating a command specifying a fault event associated with the vehicle, and transmitting the command to an on-board diagnostic system of the vehicle. The command specifies at least one of identification of the vehicle, a controller of the vehicle, a subsystem of the vehicle, and a type of fault to be monitored. A wireless communication device may be provided to communicate with the on-board diagnostic system of the vehicle in a wireless manner. In one aspect, the data processing system is non-integral to the vehicle. In another aspect, the command includes information for establishing communications with a designated data processing system external to the vehicle. In still another aspect, the command is generated based on an input from a user of the data processing system.

In one embodiment, the instructions, upon execution by the data processor, further control the data processor to receive information related to an occurrence of the specified fault event from the on-board diagnostic system of the vehicle. The information related to the occurrence of the specified fault event is generated by the on-board diagnostic system by monitoring the operation of the vehicle, and responsive to the occurrence of the specified fault event, preparing the information related to the specified fault event. Based on the received command, the on-board diagnostic system establishes communications with the designated data processing system to convey the information related to the specified fault event. In another embodiment, the designated data processing system is the same data processing system that generates the command, or a system different from the data processing system that generates the command.

Additional advantages and novel features of the present disclosure will be set forth in part in the description which follows, and in part will become apparent to those skilled in the art upon examination of the following, or may be learned by practice of the present disclosure. The drawings and description are to be regarded as illustrative in nature, and not as restrictive. The advantages of the present disclosure may be realized and attained by means of the instrumentalities and combinations particularly pointed out in the appended claims.

### BRIEF DESCRIPTION OF THE DRAWINGS

The present disclosure is illustrated by way of example, and not by way of limitation, in the accompanying drawings, wherein elements having the same reference numeral designations represent like elements throughout and wherein:

FIG. 1 is a block diagram of a data collection center and a vehicle implemented with a diagnostic system that is configured to communicate with the data collection center in a wireless manner.

FIG. 2 depicts detailed structure of an exemplary diagnostic system for use with a vehicle.

FIG. 3 shows an exemplary data format of a fault alert command.

FIG. 4 is a block diagram of another exemplary diagnostic system for use with a vehicle.

FIG. 5 depicts a block diagram of an exemplary data processing system upon which a data collection center may be implemented.

### DETAILED DESCRIPTIONS OF ILLUSTRATIVE EMBODIMENTS

In the following description, for the purposes of explanation, numerous specific details are set forth in order to provide a thorough understanding of the present disclosure. It will be apparent, however, to one skilled in the art that concepts of the disclosure may be practiced or implemented without these specific details. In other instances, well-known structures and devices are shown in block diagram form in order to avoid unnecessarily obscuring the present disclosure.

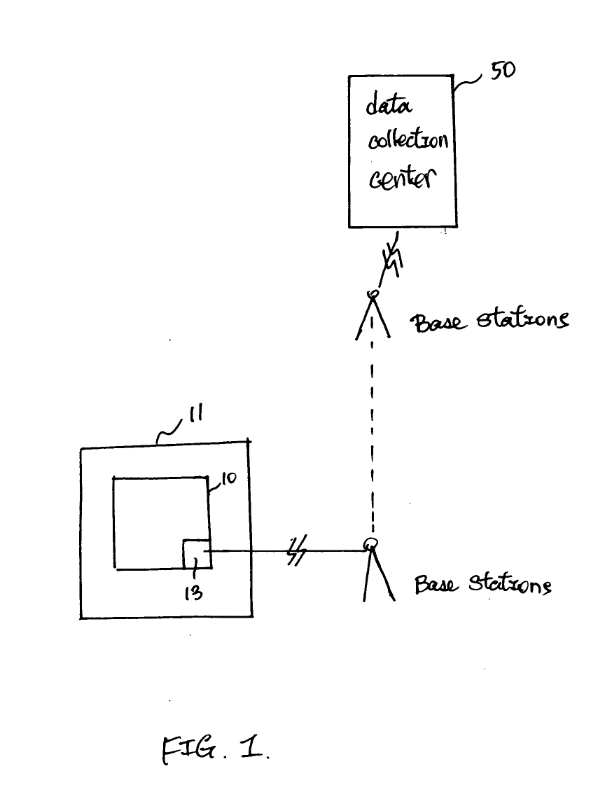

FIG. 1 depicts an exemplary data collection operation according to this disclosure. A vehicle 11 is equipped with an on-board diagnostic system 10 and a wireless communication device 13. A data collection center 11, implemented with data processing systems, such as servers or computers, is provided to form wireless communications with on-board diagnostic system 10. For instance, as illustrated in FIG. 1, a wireless communication link is established between on-board diagnostic system 10 and data collection center 50 by utilizing base stations of a mobile phone network. Other wireless means can also be used to implement communications between data collection center 50 and on-board diagnostic system 10, such as point-to-point radio communications, Bluetooth, wireless LAN, infrared communications, GSM, PHS, CDMA, etc.

In collecting fault data related to vehicle 11, data collection center 11 issues one or more commands designating vehicle 11 to perform a monitor and report session to monitor and report specific types of information or fault occurring on vehicle 11. The commands are generated based on information entered by an operator or a machine, or a combination of both. The generated commands are sent to on-board diagnostic system 10 via a wireless communication link. The commands are configurable to designate one or more specific signals, information related to one or more specific subsystems, components, parts, and/or controllers of vehicle 11, one or more specific types of faults, or any combinations thereof, or any type of information and/or signals that data collection center 50 wishes to receive, etc. In one embodiment, the commands include information related to a destination data processing system to which diagnostic system 10 should send fault information, and any additional information needed to establish communications with the destination data processing system, such as a phone number, an IP address, a radio frequency, a communication protocol, etc. The destination data processing system can be data collection center 50 itself or a data processing system different from data processing center 50.

Once the commands are received by diagnostic system 10 via wireless communication device 13, diagnostic system 10 establishes a monitor and report session to monitor and report the operation of vehicle 11 based on the contents of the received commands. When a fault corresponding to that specified in the commands occurs in vehicle 11 or the type of information designated in the commands is available, diagnostic system 10 assembles and conveys a fault alert message to the destination data processing system based on the information included in the commands. For instance, diagnostic system 10 establishes a data link to send the fault alert message to the destination data processing system by calling a specific phone number. The data link can be a wireless communication link, a data network link, such as the internet, etc.

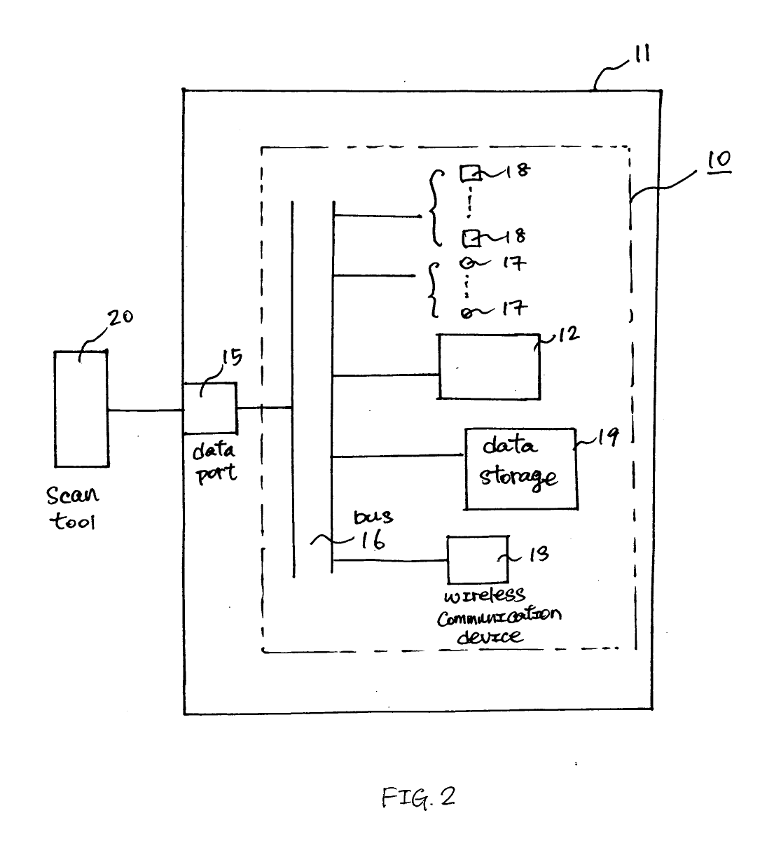

FIG. 2 depicts detailed structures of diagnostic system 10 and wireless communication device 13. Sensors 17 and electronic control units (ECUs) 18 are disposed at various portions of vehicle 11 to control the operations, and collect operation data, of various subsystems or parts of the vehicle, such as engine, transmission, tires, electronic system, AC, oil level, emissions, etc. Each ECU 18 is assigned a unique ID. Diagnostic system 10 further includes a data processor 12 and a data storage device 19 for storing data. Examples of data storage device 19 include floppy disks, hard disk drives, magnetic tapes, optical disks, such as CD-ROM, DVD, semiconductor storage devices, such as RAM, PROM, and EPROM, FLASH-EPROM, memory chips or cartridges, etc., or any combinations thereof. Data processor 12, data storage device 19, sensors 17 and ECUs 18 are coupled to a diagnostic bus 16.

Data processor 12 executes instructions stored in data storage device 19 and performs diagnoses on various subsystems of vehicle 11 based on information provided by ECUs 18 and sensors 17. Data or information generated by diagnostic system 10 may be selectively sent to data collection center 50 or destination data processing systems via wireless communication device 13, based on commands received from data collection center 50. Detailed operations of the communications between diagnostic system 10 and data collection center 50 will be described shortly.

A data port 15 is provided for coupling to external devices, such as a scan tool 20. Examples of data port 15 include OBD II interface, USB connectors, wireless transceivers, or any type of data outlet for transmitting and/or receiving data. Examples of scan tools include SOLUS™ Scanner made by Snap-on Inc. Scan tool 20 may further couple to another data processing system or a data network, such as the internet, so that data generated by diagnostic system 10 or scan tool 20 can be transmitted to, or accessed by, other data processing systems.

Each ECU 18 in vehicle 11 is in charge collecting information related to the operations of one or more subsystems and/or components of vehicle 11 by constantly obtaining operation parameters associated with the subsystem(s), such as temperatures, pressures, rpm, etc. Based on the collected operation parameters, an ECU 18 determines the operation status of the associated subsystem or components. When a fault or abnormality occurs in a subsystem or component, the associated ECU generates a fault code uniquely identifying the occurred fault, and sends the fault code to data processor 12.

Data processor 12, in response to receiving a fault code representing the occurrence of a fault specified in the commands received from data collection center 50, assembles and sends a fault alert message including information related to the occurred fault to the designation data processing system for further processing. The information included in the fault alert message comprises the fault code, historical operation data of the subsystem associated with the fault code or vehicle 11, any information specified in the commands received from data collection center 11, etc.

In one embodiment, ECUs 18 only collects information or operation parameters of their respective subsystems or components. The collected information or parameters are sent to data processor 12. Based on the information and/or parameters received from ECUs, data processor 12 evaluates the operation status of the subsystems and/or components of vehicle 11 and determines whether a fault or abnormality occurs in vehicle 11. If a fault indeed occurs, an appropriate fault code uniquely identifying the fault is generated. Similar to the embodiment discussed earlier, data processor 12 assembles and sends a fault alert message including information related to the occurred fault to the designation data processing system for further processing. The information included in the fault alert message comprises the fault code, historical operation data of the subsystem associated with the fault code or vehicle 11, any information specified in the commands received from data collection center 11, etc.

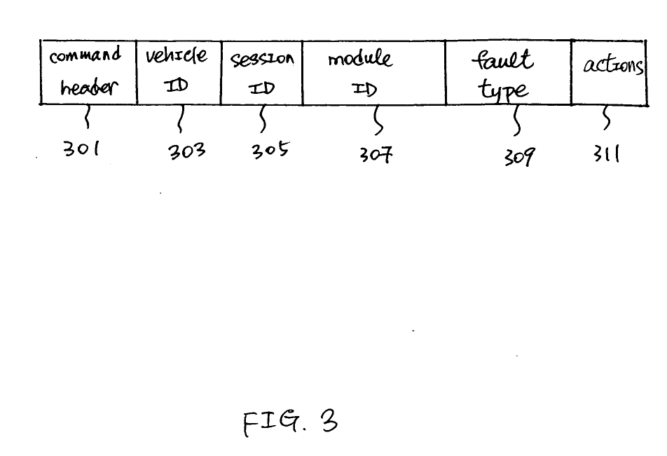

FIG. 3 shows an exemplary command format used by data collection center 50 in designating vehicles and the types of faults and/or information that the designated vehicles need to monitor and report. Data field 301 is a command header identifying the command being a command for configuring fault alert sessions. Data field 303 includes information designating a vehicle that the command intends to reach and control. Data field 305 is a session ID uniquely identifying a specific monitor and report session initiated by a specific data collecting center. A data collection center may issue more than one command to a same vehicle to initiate monitoring and reporting information related to different subsystems, components and/or faults. In addition, more than one data collection center may issue commands requesting the same vehicle to monitor and report information related to the same subsystem, component and/or fault. The session ID allows vehicles to distinguish one monitor and report session from others.

Data field 307 includes a module ID specifying a specific ECU, subsystem, component and/or part in vehicle 11, for which diagnostic system 10 needs to monitor and report information. Data field 309 describes the type of information or faults that vehicle 11 needs to monitor and report. For instance, data field 309 may specify monitoring a specific type of fault or all faults associated with a specific ECU. Data field 311 includes information specifying the type of actions that vehicle 11 needs to take with respect to the command. For instance, an “activate” action requires vehicle 11 to start performing a monitor and report session as described in the command; a “cancel” action requires vehicle 11 to cancel performing the monitor and report session as described in the command; and a “reinstate” command controlling vehicle 11 to re-enable a specific monitor and report session that was previously disabled.

In addition to the exemplary command format shown in FIG. 3, data collection center 50 uses other types of commands to control the monitor and report sessions handled by diagnostic system 10 of vehicle 11. For instance, data collection center 50 may issue a remove_all_fault_alert command to cancel all existing monitor and report sessions or a re-eanble_all_fault_altert command to reinstate all monitor and report sessions.

Once the commands sent by data collection center 50 are received by diagnostic system 10, diagnostic system 10 performs actions according to the contents of the received commands. For example, responsive to a received command specifies monitoring and reporting a specific type of fault associated with a specific ECU, data processor 12 keeps track of the occurrence of the fault specified in the command. If the specified command indeed occurs, data processor 12 assembles a fault alert message including information related to the occurred fault, such as fault codes, time stamps, historical operation data, temperatures, rpm, etc., and sends the fault alert message to a pre-designated destination data processing system, or a designation data processing system as specified in the received commands.

The transmission of the fault alter message is performed via wireless communication device 13, scan tool 20, or via any communication devices coupled to diagnostic system 10.

In one embodiment, once a fault alert message related to a specific fault is sent to the destination data processing system, diagnostic system 10 disables the monitor and report session associated with the specific fault. In other words, no further report related to the specific fault is set to data collection center 50, to avoid duplicated fault alert messages and to minimize communication traffic and cost.

After a specific fault occurs, the fault may be cleared or fixed subsequently. For instance, the driver may bring the vehicle to a service center to fix the specific fault. The specific fault may also disappear simply by restarting the vehicle. If diagnostic system 10 determines that a specific fault subject to monitoring and reporting has been reported and subsequently cleared or fixed, diagnostic system 10 automatically re-enables the monitor and report session associated with the specific fault. Therefore, if the specific fault occurs again, a new fault alert message is assembled and transmitted by diagnostic system 10.

Diagnostic system 10 has the capacity of determining whether a maintenance process or repair work has been performed or completed on vehicle 11 to clear a specific fault. In one embodiment, during a diagnostic process, scan tool 20 is connected to OBD II port 15 to download fault codes stored in diagnostic system 10. Based on the downloaded fault codes, a technician determines what symptoms or problems are encountered by vehicle 11, and what types of faults occurred in which subsystems of vehicle 11. Appropriate analysis and repair can then be performed to pinpoint trouble spots and cure the problem. If needed, old ECUs 18 or parts are replaced by new ECUs or parts. After a technician finishes a maintenance job to repair certain subsystems of vehicle 11, the technician is required to issue an erase command or a clear code via scan tool 20 to clear the fault codes stored in diagnostic system 10. The format of the erase command or clear code may be in the format of:

ID of erase command+ID of fault code to be erased

For instance, according to the SAE (Society of Automotive Engineers) Recommended Practices, a technician is required to issue a DM3 command or PID 195 command to erase fault codes stored in diagnostic system 10. In response to the erase command or clear code, the fault code associated with the fixed problem is removed or erased from the data storage device 19 and/or associated ECUs 18. Diagnostic system 10 constantly monitors commands sent from scan tool 20. According to the receipt of an erase command or clear code, diagnostic system 10 determines that a maintenance process has occurred or completed. Based on the content of the erase command, the fault code to be erased by the erase command can be determined.

According to another embodiment, the occurrence or completion of a maintenance process is determined based on a change of a fault code list maintained in diagnostic system 10. Diagnostic system 10 stores a list of all fault codes representing all errors encountered by vehicle 11. As discussed earlier, whenever a problem is fixed, the technician is required to issue an erase command or clear code to remove the corresponding fault code stored in ECUs and/or the list of fault codes maintained by diagnostic system 10. Thus, the removal of a fault code from the list indicates that a maintenance process has been performed on vehicle 11 to repair certain problems.

In generating a fault alert message, diagnostic system 10 includes data related to a diagnostic process that cured a specific fault into the fault alert message. The data can be entered by a technician or collected from any diagnostic devices that were used in fixing the fault. The data included in the fault alert message may be any data that is stored in scan tool 20 and/or diagnostic system 10, and associated with the failed parts, the performed tests and diagnoses, attributes of the vehicles (year, make, model, engine particulars, etc.), symptoms or faults, effective tests for finding causes of a specific symptom, effective fixes corresponding to a specific fault, measurements obtained during the diagnoses, information obtained from vehicle on-board computers, additional comments/descriptions entered by technicians, ineffective tests/fixes corresponding to various symptoms/faults, information related to the technician who conducted the diagnostics, etc. Detailed descriptions of the process to collect and send data related to a fault and diagnoses of the fault are provided in a co-pending patent application (attorney docket No. 66396-253), titled “VEHICLE DIAGNOSTIC METHOD AND SYSTEM WITH INTELLIGENT DATA COLLECTION,” commonly assigned to the assignee of this application, the disclosure of which is incorporated herein by reference in its entirety.

After the fault alert message is transmitted to data collection center 50 or the destination data processing systems, information included in the fault alert message can be used for data mining and/or any further analyses and uses. Detailed process related to data mining and further processing of the transmitted data are described in U.S. patent application Ser. No. 10/613,23 (attorney docket No. 10473-998), titled DISTRIBUTED EXPERT DIAGNOSTIC SERVICE AND SYSTEM, filed on Jul. 7, 2003 and commonly assigned to the assignee of this application, the disclosure of which is incorporated herein by reference in its entirety.

According to another embodiment, when a fault occurs on a vehicle, the on-board diagnostic system prepares and sends a fault alert message related to the occurred fault to a designated data processing system, such as data collection center 50 as described earlier with respect to FIG. 1. In response to the fault alert message, data collection center 50 determines what additional information is needed to perform an effective diagnosis of the fault, and generates and sends one or more new commands to the vehicle requesting the needed information. The vehicle, in response to the new commands sent by data collection center 50, assembles and sends the needed information to data collection center 50. Based on the new information provided by the vehicle, data collection center 50 performs diagnosis. In one embodiment, the additional information includes the location of the vehicle by utilizing signals of a location system, such as GPS or mobile phone. In another embodiment, information related to the diagnosis performed by data collection center 50 is sent to a service center closest to the location of the vehicle, a garage preferred by the vehicle owner, or any garage designated by data collection center 50 or the vehicle owner, such that the service centers or garages are aware of the conditions of the vehicle before the vehicle arrives, which increases the service efficiency. Furthermore, based on the location information provided by the vehicle, data collection center 50 may notify a service center to provide assistance or towing service to the vehicle.

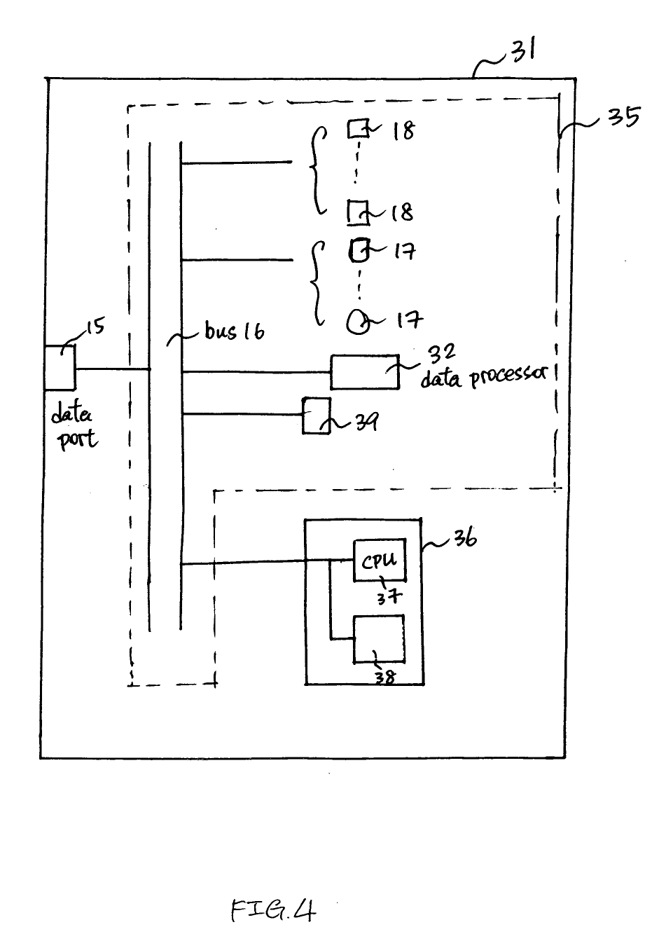

FIG. 4 depicts a block diagram of another exemplary diagnostic system 30 for use with an on-board diagnostic system 35 of a vehicle 31. On-board diagnostic system 35 is substantially similar to the diagnostic system 10 shown in FIG. 1. Elements having the same reference numeral designations represent like elements throughout. Data processor 32 executes instructions stored in storage device 39 and performs diagnoses on various subsystems of vehicle 31 based on information provided by ECUs 18 and sensors 17, and records fault codes in data storage device 19.

In this embodiment, diagnostic system 36 is implemented as a device separate from on-board diagnostic system 35, and is used to handle communications with data collection center 50 and/or destination data processing systems, as well as fault monitor and report sessions as discussed in earlier embodiments. A data processor 37 is provided to process data and execute instructions. Diagnostic system 36 further includes a wireless communication device 38. Diagnostic system 36 is detachably connected to on-board diagnostic system 35 via a connector which couples diagnostic system 36 to bus 16 of on-board diagnostic system 35.

When diagnostic system 36 is first installed on vehicle 31, CPU 37 performs communications with data processor 32 of on-board diagnostic system 35 and other devices on vehicle 31 to obtain information related to vehicle 31 and ECUs 18. Diagnostic system 36 then performs an enumeration process by establishing a wireless data link with data collection center 50 via wireless communication device 38, according to information presorted in diagnostic system 36. After the data link is established, diagnostic system 36 provides information of vehicle 31 and diagnostic system 36 to diagnostic center 50, such that data collection center 50 is aware of the relationship between vehicle 31 and diagnostic system 36, and the protocols and/or parameters to be used in communicating with diagnostic system 36.

In operation, data collection center 50 generates and sends commands related to faults to be monitored and reported to diagnostic system 36 via wireless communication device 38, as discussed in earlier embodiments. Based on the software installed on diagnostic system 38, CPU 37 performs the functions related to fault monitoring and reporting, data collection, data communications as described above related to FIGS. 1-3.

CPU 37 constantly monitors the signals and traffic on bus 16. As discussed earlier, after the technician finishes a maintenance job to repair certain subsystems of vehicle 31, the technician is required to issue an erase command or a clear code via a scan tool connected to data port 15 to clear the fault codes stored in on-board diagnostic system 35. The clear code is sent from the scan tool to on-board diagnostic system 35 via bus 16. According to the receipt of an erase command or clear code detected on bus 16, diagnostic system 36 determines that a maintenance process has occurred or completed. Based on the content of the erase command, the fault code to be erased by the erase command can be determined.

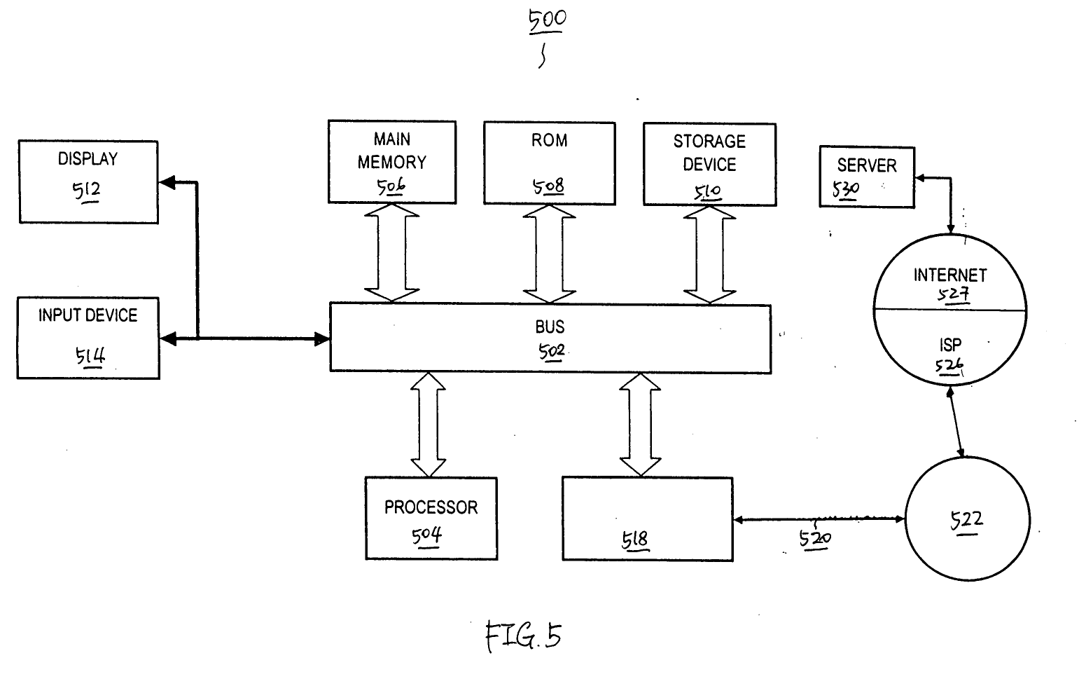

FIG. 5 is a block diagram that illustrates a data system 500 upon which an exemplary data collection center and destination data processing systems of this disclosure may be implemented. Data processing system 500 includes a bus 502 or other communication mechanism for communicating information, and a processor 504 coupled with bus 502 for processing information. Data processing system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Data processing system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Data processing system 500 may be coupled via bus 502 to a display 512, such as a cathode ray tube (CRT), for displaying information to a data processing user. An input device 514, including alphanumeric and other keys, is coupled to bus 502 for communicating information and command selections to processor 504. Another type of user input device is cursor control, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

According to one embodiment of the disclosure, the generation of fault alert commands and communications with diagnostic systems 10 and 36 are provided by data processing system 500 in response to processor 504 executing one or more sequences of one or more instructions contained in main memory 506 or storage device 510, or received from the network link 520. Such instructions may be read into main memory 506 from another data processing-readable medium, such as storage device 510. Execution of the sequences of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement the disclosure. Thus, embodiments of the disclosure are not limited to any specific combination of hardware circuitry and software.

The term “data processing-readable medium” as used herein refers to any medium that participates in providing instructions to processor 504 for execution. Such a medium may take many forms, including but not limited to, non-volatile media, volatile media, and transmission media. Non-volatile media include, for example, optical or magnetic disks, such as storage device 510. Volatile media include dynamic memory, such as main memory 506. Transmission media include coaxial cables, copper wire and fiber optics, including the wires that comprise bus 502. Transmission media can also take the form of acoustic or light waves, such as those generated during radio frequency (RF) and infrared (IR) data communications. Common forms of data processing-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing can read.

Various forms of data processing readable media may be involved in carrying one or more sequences of one or more instructions to processor 504 for execution. For example, the instructions may initially be borne on a magnetic disk of a remote data processing. The remote data processing can load the instructions into its dynamic memory and send the instructions over a telephone line using a modem. A modem local to data processing system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506, from which processor 504 retrieves and executes the instructions. The instructions received by main memory 506 may optionally be stored on storage device 510 either before or after execution by processor 504.

Data processing system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to data equipment operated by an Internet Service Provider (ISP) 526. ISP 526 in turn provides data communication services through the worldwide packet data communication network, now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from data processing system 500, are exemplary forms of carrier waves transporting the information.

Data processing system 500 can send messages and receive data, including program code, through the network(s), network link 520, and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution. In this manner, data processing system 500 may obtain application code in the form of a carrier wave.

In the previous descriptions, numerous specific details are set forth, such as specific materials, structures, processes, etc., in order to provide a thorough understanding of the present disclosure. However, as one having ordinary skill in the art would recognize, the present disclosure can be practiced without resorting to the details specifically set forth. In other instances, well known processing structures have not been described in detail in order not to unnecessarily obscure the present disclosure.

Only the illustrative embodiments of the disclosure and examples of their versatility are shown and described in the present disclosure. It is to be understood that the disclosure is capable of use in various other combinations and environments and is capable of changes or modifications within the scope of the inventive concept as expressed herein.

What is claimed is:

1. A method for obtaining fault alerts related to a vehicle, the method comprising the machine-executed steps of:
receiving a configurable command from the external of the vehicle specifying a fault event associated with the vehicle;
monitoring the operation of the vehicle;
responsive to an occurrence of the specified fault event, preparing information related to the specified fault event; and
providing the information related to the specified fault event to a data processing system external to the vehicle.

2. The method of claim 1, wherein the information is transmitted to the data processing system in a wireless manner.

3. The method of claim 1, wherein the command includes at least one data field specifying at least one of identification of the vehicle, a controller of the vehicle, a subsystem of the vehicle, and a type of fault to be monitored.

4. The method of claim 1, wherein the command is received from the data processing system in a wireless manner or from a device connected to a data port of the vehicle.

5. The method of claim 4, wherein the command is received from the data processing system using a wireless telephone network.

6. The method of claim 1 further comprising the step of responsive to the transmission of the information related to the specific fault event to the data processing system, ceasing subsequent transmission of information related to the specific fault event to the data processing system.

7. The method of claim 6 further comprising the step of responsive to the specific fault event being cleared, allowing transmission of information related to the specific fault event to the data processing system should the specific fault event occurs again.

8. A method for obtaining fault alerts related to a vehicle, the method comprising the machine-executed steps of:
generating a command specifying a fault event associated with the vehicle, wherein the command specifies at least one of identification of the vehicle, at least one controller of the vehicle, at least one subsystem of the vehicle, and at least one type of fault to be monitored; and
transmitting the command from the external of the vehicle to an on-board diagnostic system of the vehicle.

9. The method of claim 8, wherein the command includes information for establishing communications with a designated data processing system external to the vehicle.

10. The method of claim 9 further comprising the machine-executed step of receiving information related to an occurrence of the specified fault event from the on-board diagnostic system of the vehicle,
wherein the information related to the occurrence of the specified fault event is generated by the on-board diagnostic system by performing the steps of:
monitors the operation of the vehicle;
responsive to the occurrence of the specified fault event, prepares the information related to the specified fault event; and
based on the received command, establishing communications with the designated data processing system to convey the prepared information.

11. The method of claim 9, wherein the designated system is the same as a system that generates the command, or is different from a system that generates the command.

12. The method of claim 9, wherein the communications with the designated data processing system is established in a wireless manner.

13. The method of claim 8, wherein the command is generated based on an input from a user.

14. A data processing system for obtaining fault alerts associated with the vehicle, the system comprising:
a data processor configured to process data; and
a data storage system storing instructions which, upon execution by the data processor, control the data processor to perform the steps of:
generating a command specifying a fault event associated with the vehicle, wherein the command specifies at least one of identification of the vehicle, a controller of the vehicle, a subsystem of the vehicle, and a type of fault to be monitored; and
transmitting the command to an on-board diagnostic system of the vehicle;
wherein the data processing system is non-integral to the vehicle.

15. The system of claim 14, wherein the command includes information for establishing communications with a designated data processing system external to the vehicle.

16. The system of claim 15, wherein:
the instructions, upon execution by the data processor, further control the data processor to perform the step of receiving information related to an occurrence of the specified fault event from the on-board diagnostic system of the vehicle, and
the information related to the occurrence of the specified fault event is generated by the on-board diagnostic system by performing the steps of:
monitoring the operation of the vehicle;
responsive to the occurrence of the specified fault event, preparing the information related to the specified fault event; and
based on the received command, establishing communications with the designated data processing system to convey the information related to the specified fault event.

17. The system of claim 15, wherein the designated data processing system is the data processing system that generates the command, or a system different from the data processing system that generates the command.

18. The system of claim 14 further comprising a wireless communication device configured to communicate with the on-board diagnostic system of the vehicle in a wireless manner.

19. The data processing system of claim 14, wherein the instructions, upon execution by the data processor, further control the data processor to perform the step of sending an erase command specifying removal of a fault code, to the on-board diagnostic system.

20. The data processing system of claim 14, wherein the command is generated based on an input from a user of the data processing system.
